(19) United States
(12) Patent Application Publication
(10) Pub. No.: US 2013/0271895 A1
(43) Pub. Date: Oct. 17, 2013

(54) USER INSTALLABLE BRANCH CIRCUIT METER

(71) Applicant: Hampden Kuhns, Reno, NV (US)

(72) Inventor: Hampden Kuhns, Reno, NV (US)

(21) Appl. No.: 13/445,375

(22) Filed: Apr. 12, 2012

(51) Int. Cl. H02B 1/42

(52) U.S. Cl. 361/622

(57) ABSTRACT

A branch circuit monitor is disclosed. According to certain embodiments, an aspect of the branch circuit monitor includes using slider sensor modules on a serial data rail.

### TECHNICAL FIELD

The disclosed embodiments relate generally to electrical devices. More particularly, the disclosed embodiments relate to circuit monitors.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 illustrates a plurality of slider sensor modules and a relay point on a serial data rail, according to certain embodiments of the invention.

FIG. 2 illustrates multiple slider sensor modules of various spacing are put on the serial data rail, according to certain embodiments of the invention.

FIG. 3 illustrates two serial data rails connected in series with a common serial cable, according to certain embodiments of the invention.

FIG. 4 illustrates the serial data rail mounted to the door of the circuit breaker panel, according to some embodiments.

FIG. 5 illustrates the exterior of the circuit breaker box, according to some embodiments.

FIG. 6 shows a circuit breaker box with a lock and a processing module, according to certain embodiments of the invention.

### DESCRIPTION OF EMBODIMENTS

Methods, systems and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, a user can install branch circuit monitors in a circuit breaker box without removing the panel board. Such an arrangement has the benefit of isolating the user/installer from dangerous high voltages behind the panel board. Branch circuit monitoring is a valuable process for measuring the energy used in different parts of a building, for example. Further, when combined with non-intrusive appliance load monitoring systems, it is possible to resolve the energy and time of use of many appliances on one or more of the circuits.

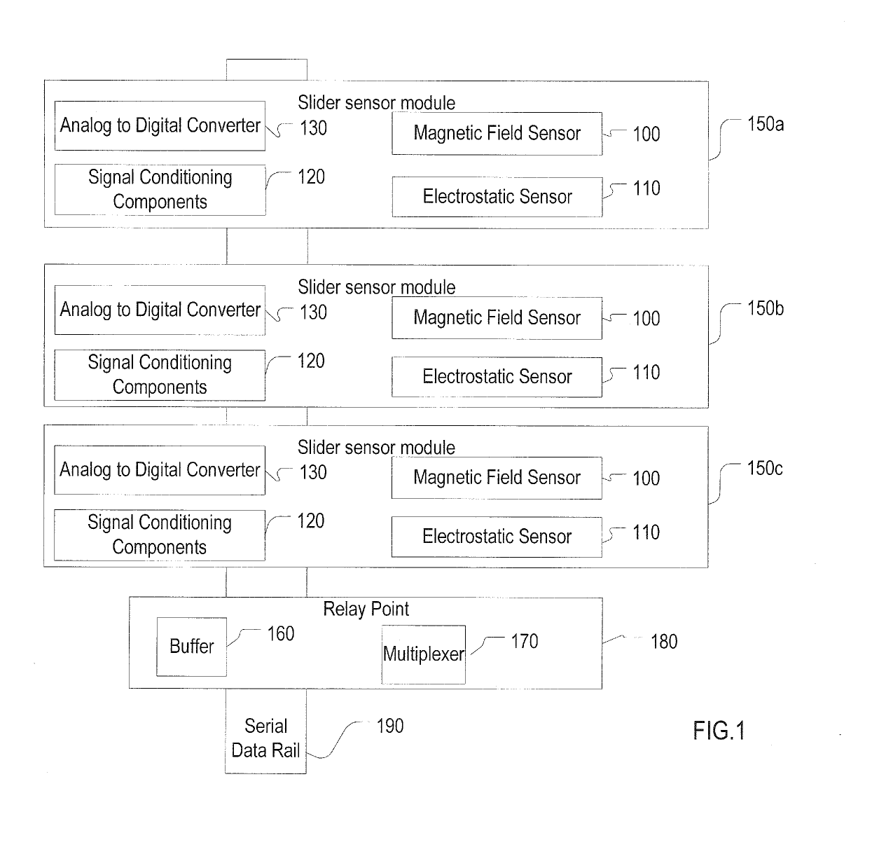

FIG. 1 illustrates a plurality of slider sensor modules (150a-c) and a relay point (180) on a serial data rail (190). According to certain embodiments, a slider sensor module (150) comprises a magnetic field sensor (100), an electrostatic sensor (110), signal conditioning module (120), and an analog to digital converter (130). The sensor modules are attached to a rail (190) so that the spacing between the sensor modules may be adjusted to align with circuit breakers in a circuit panel.

The magnetic field sensor (100) on the slider sensor module (150) is placed adjacent to the surface of a circuit breaker to measure a signal that is a primarily related to the electrical current running through the circuit breaker as well as other currents in the panel such as the main breaker. Magnetic field sensors using magneto resistive technologies are commercially available (Honeywell HMC1001, Analog Devices AD22151, Sentron SA-1, etc) and newer systems using magnetic tunnel junctions offer higher dynamic range and sensitivity (Micromagnetics SpinTJ-340).

Non-contact voltage measurement is possible using amplified electronic testers (also called electrical tester pens, test pens, or voltage detectors). Non-contact voltage detectors rely on capacitive current only, and detect the changing electric field around AC energized objects (i.e., the conductor inside the circuit breaker). Thus, no direct metallic contact with the circuit is required. Low cost. AC voltage sensing systems are available such as the Klein NCVT-2, Extech DV24, and Greenlee Textron GT11. The non-contact voltage detector uses an electrostatic sensor (110) that functions by placing a field sensing probe close to the surface of interest, but without contacting the surface. The electrostatic sensor drives the conductive housing of the field sensing probe to a voltage necessary to null the electric field between the field sensing probe and the surface of interest. Electrostatic voltage sensors can use a closed-loop voltage feedback with high-voltage follower amplifier located on the electrostatic sensor, which yields very high accuracy, excellent stability, and low drift performance for the electrostatic voltmeter. A field nulling system can be made very precise as with the TREK® 875 contactless voltage detector (www.trekinc.com).

Frequency response for these electrostatic field sensors can be low˜40 Hz so that the units may not be able to provide complete 50 Hz-60 Hz waveforms for the voltage cycles however they are sufficient to provide a signal proportional to the RMS voltage at 1 second time intervals.

Signal voltages from the magnetic field sensors (100) and the electrostatic sensors (110) need to be conditioned prior to digitization. A signal conditioning module (120) filters the raw signal to remove low and/or high frequency noise and amplifies/divides the voltage to be optimally measured by the analog to digital converter (130).

The analog to digital converter (130) on slider sensor module (150) reads the conditioned voltages from the sensors (100, 110, 120), and sends the signal along the serial data rail (190) using a standard serial protocol such as I2C or Serial Peripheral Interface (SPI). Data from numerous sensors (100, 110, 120) are transmitted along common electrical traces in the serial data rail (190). Spacers with independent electrical connectors between the slider sensor modules (150a-c) are required for some serial protocols (e.g., SPI) whereas common traces on the rails are sufficient for other serial protocols (e.g., I2C). Some serial protocols require a relay point (180) that aggregates signals from several slider sensor modules (150) with a buffer (160) and/or a multiplexer (170) as shown in FIG. 1. In some embodiments, a shielding system is used to improve the isolation and sensitivity of both the current and magnetic field sensing portions of the system.

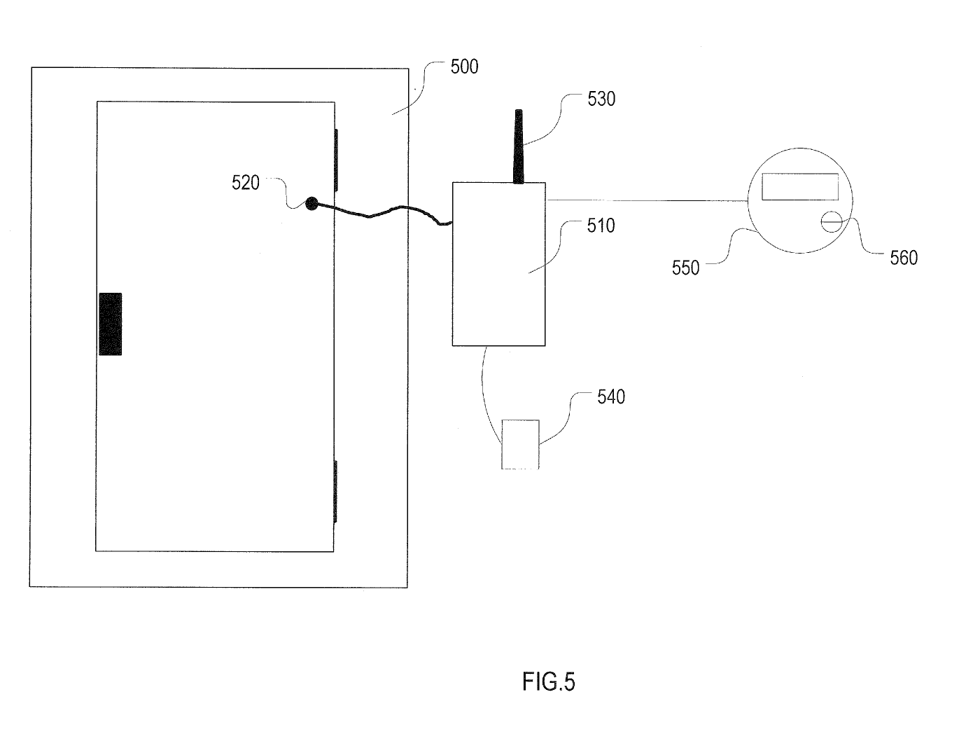

The slider sensor modules (150) each have multiple electrical contacts in place so that when all pieces are installed on the serial data rail (190), signals from each slider sensor module can be read from one end of the serial data rail into a digital input to a processor (e.g., see processor in FIG. 5). A daisy chain configuration using a serial communications protocol (such as SPI or I2C) would enable connectivity with a minimal number of connectors (electrical contacts between the sensors and the rail) on each sensor. For some communication protocols (i.e. SPI), a signal carrying spacer may be required to properly daisy chain the slider sensor modules (150).

The magnetic field sensor (100) and the electrostatic sensor (110) provide a voltage signal that is predominantly proportional to the current and voltage in closest circuit. Interference occurs from neighboring circuits. With simultaneous measurement of each circuit, these effects can be filtered using a cross-correlation technique to extract the most significant signals from each circuit. Interference from nearby circuits will create an additive signal at the measurement point. The signal from the sampled circuit breaker can be represented as a function of all measured field signals and their corresponding coefficients. These coefficients are determined during routine operation and continuously refined.

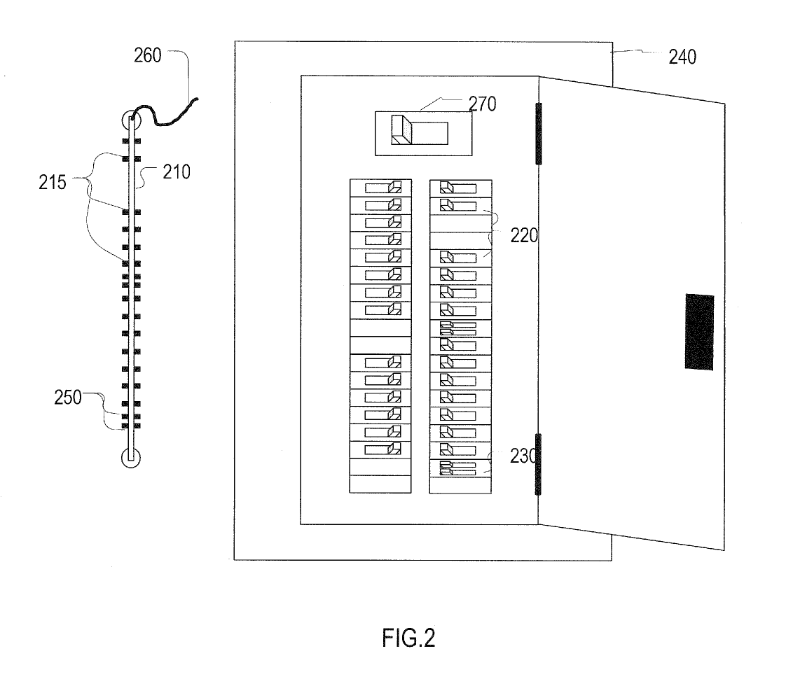

FIG. 2 illustrates multiple slider sensor modules (215) of various spacing are put on the serial data rail (210) to align with circuit breakers (220) that may not be uniformly spaced in the circuit breaker panel (240). FIG. 2 also shows a signal connector cable (260) used to transmit the signal from each slider sensor module. In most US circuit breaker panels, circuit breakers (220 and 230) are separated by either one inch or three quarter inch spacing. In addition, some single circuit breaker modules host two single poles (230). The nominal size of the slider sensor module is at most half of the size needed for the smallest three quarter inch circuit so that it can measure both circuits on a two single pole breaker (250). Individual contactless slider sensor modules (150) may also be mounted to the main circuit breaker (270).

The slider sensor module body has a flexible mounting so that when the rail is pushed against the circuit breakers each slider sensor module will make physical contact with the circuit breaker to standardize the distance of the slider sensor module to the current carrying wire inside the circuit breaker. According to certain embodiments, one serial data rail with slider sensor modules is installed for each row of circuit breakers in the panel.

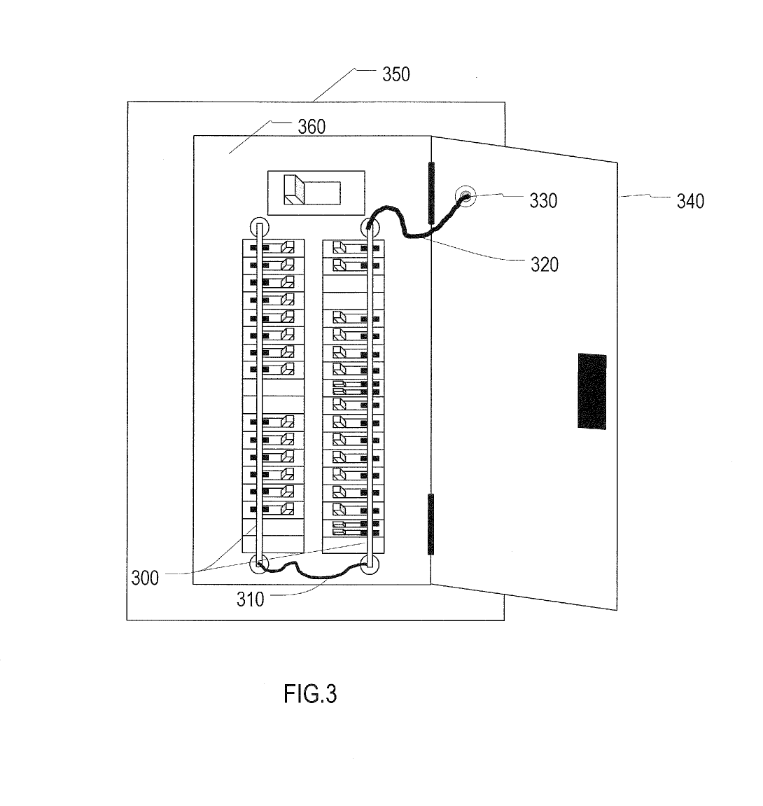

FIG. 3 illustrates two serial data rails (300) connected in series with a common serial cable (310), according to certain embodiments. One of the rails is connected via a serial cable (320) to a weather proof bulkhead fitting (330) on the panel door (340) to transmit the low voltage signal out of the door of the circuit breaker box (350). According to certain other embodiments, the serial data rails can be connected in parallel.

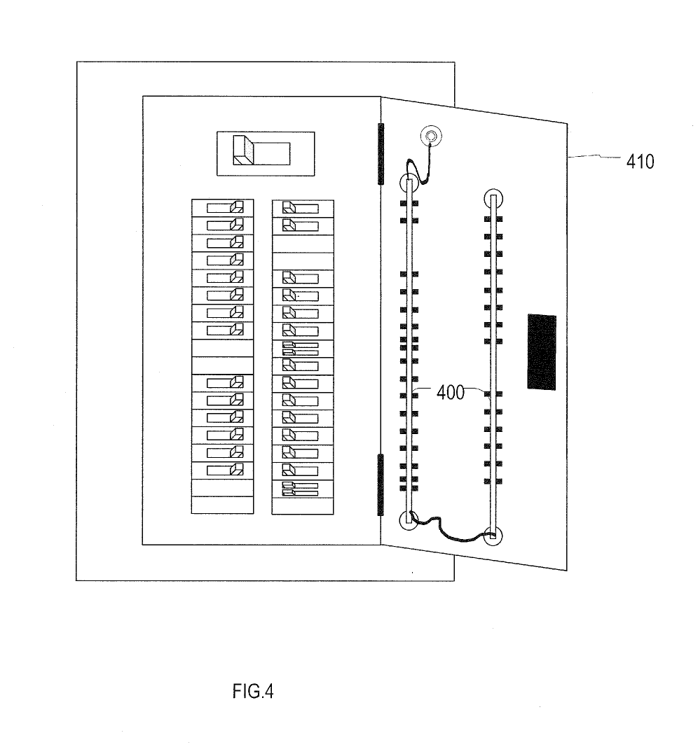

Installation options for the serial data rails include mounting the serial data rails to the dead front (360) of the panel as shown in FIG. 3 or mounting the serial data rails (400) to the door (410) of the circuit breaker panel as shown in FIG. 4.

FIG. 5 illustrates the exterior of the circuit breaker box (500). The processing module (510) analyzes the signal from the low voltage weatherproof connector (520) and communicates the analysis data through a wireless network connection (530) to a gateway or directly to the internet. Data connections to local or remote servers may also be wired through protocols such as Ethernet, RS232, 2-Wire BacNET, etc. The processing module is powered with AC power (540) from a nearby receptacle.

An alternative power source for the system includes a solar panel charging a battery connected to the processing module. Such a configuration reduces maintenance and installation costs since a nearby receptacle is not necessary for installation. In some embodiments, energy scavenger modules driven by the magnetic fields inside the panel and mounted on the slider sensor module may also charge a battery or energy storage device that powers the processor module.

The processing module (510) will perform one or more of the following steps of signal processing: (1) cross correlation filtering to remove interfering signals measured on the slider sensor modules, (2) polling a smart meter or other aggregate power monitoring device to receive a calibrating signal for current and voltage measurements on the slider sensor modules, (3) applying a non-intrusive load monitoring algorithm to disaggregate signals measured on one or more circuits, (4) relaying the raw or processed data to a network server, and (5) communicating isolated signals to end users through a web interface.

External inputs signals can be used to calibrate these signals to create a quantifiable measure. Smart meters (550) provide two mechanisms of communicating voltage, current, and real power used at a service point connected infrared port (560) and wireless communications. While these protocols vary from one meter to the next, it is possible to use these signals at intervals of six seconds or longer to provide a reference to calibrate voltages and currents measured on the system. With such an approach, it is possible to continuously update the calibration of the sensors if their performance changes over time. Calibration and interference calculations will be halted when all sensed voltages and current signals reduce simultaneously. This event implies that the slider sensor modules are no longer in contact with the circuit breakers.

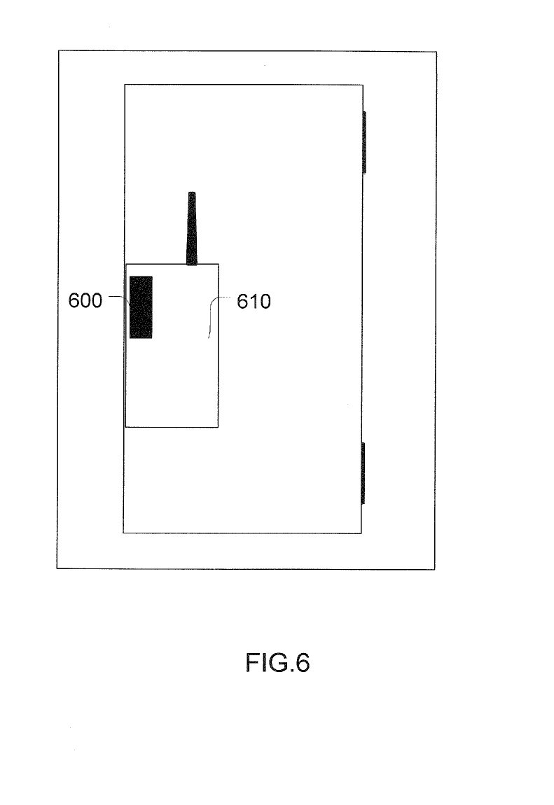

Most US circuit breaker boxes have a lock that has an opening of inch wide by three and one half inches tall. FIG. 6 shows a circuit breaker box with a lock (600) and a processing module (610). Lock (600) is removable to create an opening and may be used as a mounting point for the low voltage connector and/or the processing module (610) that may be mounted outside the circuit breaker box. According to certain embodiments, the processing module (610) is secured to the door via such an opening and a panel lock is built into the processing module as show in FIG. 6. In other embodiments, only the weather proof low voltage connector is integrated into the replacement lock. Using this opening eliminates the need to create a new penetration in the circuit panel door.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A branch circuit monitor, the branch circuit monitor comprising:
one or more slider sensor modules;
one serial data rail; and
wherein the one or more slider sensor modules adjustably slide on the serial data rail to align with respective circuit breakers on a circuit breaker box for measuring energy consumption without removing a panel board of the circuit breaker box.

2. The branch circuit monitor of claim 1, further comprising a relay point module for aggregating signal data from the one or more slider sensor modules and communicating the signal data to a signal processor.

3. The branch circuit monitor of claim 1, further comprising an analog to digital converter in the one or more slider sensor modules.

4. The branch circuit monitor of claim 1, wherein the one or more slider sensor modules include at least one magnetic field sensor, at least one electrostatic sensor and at least one signal conditioning module.

5. The branch circuit monitor of claim 1, wherein the serial data rail carrying the one or more slider sensor modules is mounted on a dead front panel of the circuit breaker box such that the one or more slider sensor modules can monitor the circuit breakers in the circuit breaker box.

6. The branch circuit monitor of claim 1, wherein the serial data rail carrying the one or more slider sensor modules is mounted on an interior surface of a door of the circuit breaker box, such that when the door is in a closed position, the one or more slider sensor modules can monitor the circuit breakers in the circuit breaker box.

7. ranch circuit monitor of claim 1, wherein signal data from the one or more slider sensor modules are transmitted to a processing module.

8. The branch circuit monitor of claim 7, wherein the processing module is capable of:
cross correlation filtering to remove interfering signals measured on the one or more slider sensor modules;
polling a smart meter or other aggregate power monitoring device to receive a calibrating signal for current and voltage measurements on the one or more slider sensor modules,;
applying a non-intrusive load monitoring algorithm to disaggregate signals measured on one or more circuits;
relaying raw or processed data to a network server; and
communicating isolated signals to end users through a web interface.
